(19) United States
(12) Patent Application Publication
(10) Pub. No.: US 2026/0341292 A1
(43) Pub. Date: Oct. 29, 2026

(54) HANDLING AUDIO ARTIFACTS WITHIN DIGITAL AUDIO

(71) Applicant: Advanced Micro Devices, Inc., Santa Clara, CA (US)

(72) Inventors: A Srinivas, Hyderabad (IN); Ravikumar Badam, Hyderabad (IN); Bhupal Lella, Hyderabad (IN)

(73) Assignee: Advanced Micro Devices, Inc., Santa Clara, CA (US)

(21) Appl. No.: 19/187,662

(22) Filed: Apr. 23, 2025

(51) Int. Cl. G10L 21/0208; G10L 17/02

(52) U.S. Cl. CPC G10L 21/0208; G10L 17/02

(57) ABSTRACT

Handling audio artifacts within digital audio includes extracting a plurality of audio generation features from a portion of a digital audio stream preceding a selected frame of the digital audio stream. A plurality of artifact detection features are extracted from the selected frame. An audio artifact within the selected frame is detected by processing the plurality of artifact detection features through a first machine learning model trained to detect audio artifacts. In response to detecting the audio artifact, a replacement frame is generated by processing the audio generation features through a second machine learning model trained to generate replacement frames. The selected frame including the audio artifact is replaced within the digital audio stream with the replacement frame.

### TECHNICAL FIELD

This disclosure relates to detecting and handling audio artifacts within digital audio.

### BACKGROUND

Digital audio processing is often a computationally intensive task for audio-enabled systems. An audio-enabled system refers to any of a variety of electronic systems or devices that are capable of playing, processing, or otherwise handling digital audio. Examples of audio-enabled systems may include, but are not limited to, computers, personal devices (e.g., mobile phones, portable music players, tablets), or other appliances such as speakers (including portable and/or smart speakers), televisions (including monitors), or the like.

As an audio-enabled system plays digital audio to a user, any audio artifacts introduced into the audio, whether glitches, breaks, interruptions, or other disruptions in the playing of audio, can be easily perceived by the user. Such audio artifacts not only degrade the user's listening experience, but may render the digital audio being played back, or portions thereof, unintelligible to the user. Even small audio artifacts may have a significant impact on the user's listening experience. This is particularly true in the case of multimedia content and/or the playing of streaming digital audio.

### SUMMARY

In one or more examples, a method includes extracting a plurality of audio generation features from a portion of a digital audio stream preceding a selected frame of the digital audio stream. The method includes extracting a plurality of artifact detection features from the selected frame. The method includes detecting an audio artifact within the selected frame by processing the plurality of artifact detection features through a first machine learning model trained to detect audio artifacts. The method includes, in response to detecting the audio artifact, generating a replacement frame by processing the audio generation features through a second machine learning model trained to generate replacement frames. The method includes, within the digital audio stream, replacing the selected frame including the audio artifact with the replacement frame.

In one or more examples, a system includes a hardware processor and one or more computer-readable storage mediums having program instructions stored thereon to cause the hardware processor to perform operations. The operations include extracting a plurality of audio generation features from a portion of a digital audio stream preceding a selected frame of the digital audio stream. The operations include extracting a plurality of artifact detection features from the selected frame. The operations include detecting an audio artifact within the selected frame by processing the plurality of artifact detection features through a first machine learning model trained to detect audio artifacts. The operations include, in response to detecting the audio artifact, generating a replacement frame by processing the audio generation features through a second machine learning model trained to generate replacement frames. The operations include, within the digital audio stream, replacing the selected frame including the audio artifact with the replacement frame.

In one or more examples, a computer program product includes one or more computer-readable storage mediums having program instructions stored thereon. The program instructions are executable by computer hardware to cause the computer hardware to initiate operations. The operations include extracting a plurality of audio generation features from a portion of a digital audio stream preceding a selected frame of the digital audio stream. The operations include extracting a plurality of artifact detection features from the selected frame. The operations include detecting an audio artifact within the selected frame by processing the plurality of artifact detection features through a first machine learning model trained to detect audio artifacts. The operations include, in response to detecting the audio artifact, generating a replacement frame by processing the audio generation features through a second machine learning model trained to generate replacement frames. The operations include, within the digital audio stream, replacing the selected frame including the audio artifact with the replacement frame.

This Summary section is provided merely to introduce certain concepts and not to identify any key or essential features of the claimed subject matter. Many other features and implementations of the disclosed technology will be apparent from the accompanying drawings and from the following detailed description.

### BRIEF DESCRIPTION OF THE DRAWINGS

The accompanying drawings show one or more implementations of the disclosed technology. The drawings, however, should not be construed to be limiting of the implementations to only the examples shown. Various aspects and advantages will become apparent upon review of the following detailed description and upon reference to the drawings.

FIG. 1 illustrates an example of a system capable of processing audio.

FIG. 2A illustrates an example of an audio processing pipeline from the system of FIG. 1.

FIG. 2B illustrates another example of an audio processing pipeline from the system of FIG. 1.

FIG. 3 illustrates an example implementation of an artifact handling system.

FIG. 4 illustrates an example method of operation for the system of FIG. 1.

### DETAILED DESCRIPTION

While the disclosure concludes with claims defining novel features, it is believed that the various features described within this disclosure will be better understood from a consideration of the description in conjunction with the drawings. The process(es), machine(s), manufacture(s) and any variations thereof described herein are provided for purposes of illustration. Specific structural and functional details described within this disclosure are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

This disclosure relates to detecting and handling audio artifacts within digital audio. In accordance with the implementations described within this disclosure, methods, systems, and computer program products are provided that are capable of handling audio artifacts within a digital audio stream. An artifact handling system, as described herein, is capable of detecting and mitigating audio artifacts in digital audio automatically and in real time to reduce the impact of the audio artifacts or eliminate the audio artifacts altogether. The example artifact handling system described herein may be incorporated into an audio processing pipeline of any of a variety of audio-enabled devices to handle audio artifacts in real time in various contexts including playback of streaming digital audio including the playing of multimedia content.

Within conventional audio playback systems, audio artifacts are often handled using packet loss concealment techniques. In cases where an audio packet is lost or corrupted, for example, the audio packet is retransmitted from a source. This technique, while useful in certain contexts such as Voice-Over Internet Protocol (VOIP) for end-to-end calls, is not suitable for other use cases such as multimedia applications and/or the streaming of digital audio. Such is the case as the very act of retransmitting the audio packet will often result in an audio artifact that is audible to a user.

Other examples of conventional techniques for handling audio artifacts include manual and offline processes. In these processes, a person such as an audio engineer applies various digital signal processing techniques to the digital audio in an attempt to lessen the impact of any audio artifacts. Such techniques, however, are not performed in real time and are not suitable for multimedia applications and/or streaming digital audio use cases. Still other conventional audio playback systems attempt to conceal audio artifacts but require large amounts of prior data to do so. These techniques are unsuitable for audio playback devices with constrained or limited processing capabilities.

In one or more examples, an artifact handling system as described herein is capable of analyzing digital audio to detect audio artifacts. The audio artifacts that are detected include those that are perceivable by a user listening to the digital audio as played through an audio playback system. In response to detecting an audio artifact, the artifact handling system is capable of generating replacement audio. The replacement audio may be artificially constructed or generated based on characteristics and/or features extracted from prior or past digital audio data. The past digital audio data may be digital audio that preceded the detected audio artifact in the same digital audio stream.

The impact of the audio artifact as detected may be reduced or eliminated by inserting the replacement audio into the digital audio stream in place of the portion of the digital audio stream that includes the detected audio artifact. The replacement audio inserted into the digital audio stream preserves the consistency and/or tonal character of the digital audio stream so that a user listening to the digital audio stream playing through an audio playback system is unlikely to detect the audio artifact or any change, break, or glitch in the digital audio stream. The user experiences consistent and seamless audio playback.

The example implementations described within this disclosure, in addition to mitigating and/or eliminating audio artifacts in digital audio streams in real time, are also capable of doing so in a power efficient manner. That is, the example implementations are less computationally intensive than conventional techniques in that the processing described may be performed in fewer clock cycles and/or using less memory than other conventional audio artifact mitigation techniques. In this regard, the example implementations may be implemented in hardware systems and/or devices to prolong or enhance battery powered operation.

Further aspects of the disclosed technology are described below with reference to the figures. For purposes of simplicity and clarity of illustration, elements shown in the figures have not necessarily been drawn to scale. For example, the dimensions of some of the elements may be exaggerated relative to other elements for clarity. Further, where considered appropriate, reference numbers are repeated among the figures to indicate corresponding, analogous, or like features.

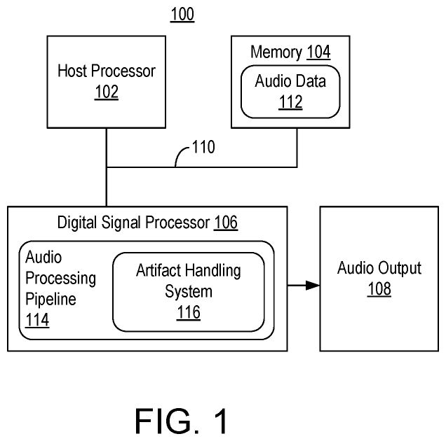

FIG. 1 illustrates an example of a system 100 capable of processing audio. System 100 is an example of a data processing system. System 100 includes a host processor 102, a memory 104, a digital signal processor (DSP) 106 and an audio output 108. Host processor 102, memory 104, and DSP 106 may be coupled by, and communicate over, interconnect circuitry 110. In one or more examples, interconnect circuitry 110 may be implemented as a communication bus.

In the example, host processor 102 and DSP 106 are implemented as hardware processors. Host processor 102 may be implemented as a central processing unit (CPU). DSP 106 may be implemented as a processor that is suited for performing digital signal processing operations including digital audio signal processing. In one or more examples, host processor 102, memory 104, and DSP 106 may be implemented as discrete ICs or packages disposed on a circuit board. In one or more other examples, host processor 102, memory 104, and DSP 106, or any combination or sub-combination thereof, may be implemented as separate circuit blocks disposed within a same die of an IC device. In one or more other examples, host processor 102, memory 104, and DSP 106, or any combination or sub-combination thereof may be implemented as separate chiplets within a same IC package.

Memory 104 may be implemented as any of a variety of volatile memory circuits. For example, memory 104 may be implemented as Double Data Rate, Synchronous Dynamic Random Access Memory (DDR) or as a High-Bandwidth Memory (HBM) stack whether disposed in the same package as one or more of the other ones of the components of FIG. 1 or implemented as a discrete, e.g., separate, component/package.

In one or more examples, system 100 implements a Hardware Offloaded Audio Processing (HAP)-enabled system. HAP is a technology that facilitates the processing of audio by offloading audio processing functions from host processor 102 to DSP 106. While FIG. 1 is described as being implemented in a variety of different configurations, in the typical case, audio data is offloaded from a host processor to a standalone DSP that exists outside or external to the host processor (e.g., the main CPU) of the data processing system. The offload process enables the DSP to operate on a buffer of audio data in regular intervals without interrupting operation of the host processor.

In the example, memory 104 stores audio data 112. Audio data 112 may be formed of a plurality of audio samples, e.g., digital audio data. For purposes of illustration and not limitation, audio data 112 may be the audio of a movie, audio of a conversation between people, audio from a documentary, music, audio of multi-media content, or other digitally recorded, streamed, and/or generated audio. In the example, host processor 102 may place portions of audio data 112 in memory 104 within buffers that may be accessed by DSP 106 in order to offload audio processing functions to DSP 106.

In one or more examples, the offloading process includes host processor 102 initiating a direct memory access (DMA) operation that delivers one or more frames of audio data 112 to DSP 106 for processing. In general, audio data 112 may be organized into “frames.” Each frame includes a plurality of audio samples of audio data 112. Each frame generally includes a same number of audio samples. In this regard, each frame may represent a particular window or amount of time of audio in terms of the time required to playback that frame.

DSP 106 may implement, e.g., execute, an audio processing pipeline 114. Audio processing pipeline 114 is capable of operating on audio data 112, e.g., frames of audio data 112, as offloaded from host processor 102. In one or more examples, audio processing pipeline 114 is implemented as a graph that specifies an audio processing framework. The graph may be formed of one or more nodes, where each node corresponds to an audio processing function specified as an application, e.g., executable program code. The application(s) may be plugin(s). Connectivity or signal routing among the nodes of the graph is specified by edges connecting the nodes.

Audio processing pipeline 114 may include, or couple to, an artifact handling system 116. Artifact handling system 116 is capable of detecting audio artifacts within audio data 112 as processed through audio processing pipeline 114. For frames of audio data 112 in which an audio artifact is detected, artifact handling system 116 is capable of artificially generating a replacement frame and inserting the replacement frame within the digital audio in place of the frame that includes the detected audio artifact. The replacement frame mitigates and/or eliminates the audio artifact such that a user listening to the digital audio being played experience smooth and consistent digital audio playback. For purposes of discussion, a frame of audio data that includes one or more audio artifacts may be referred to herein from time-to-time as an “artifact frame.” A frame of audio data that does not include any audio artifacts may be referred to herein from time-to-time as a “clean frame.”

Audio data 112, as processed by DSP 106 executing audio processing pipeline 114, may be provided to audio output 108. Audio output 108 may be implemented as hardware, e.g., circuitry, capable of outputting digital audio and/or analog audio. For example, audio output 108 may be a digital audio interface capable of outputting digital audio in any of a variety of different digital formats, converting digital audio to analog audio and outputting the analog audio, and/or wirelessly transmitting and/or streaming digital audio to other endpoints (e.g., devices). For example, audio output 108 may drive or connect to an external speaker, a powered speaker, a personal audio playback device such as headphones, earbuds, or the like.

In the example of FIG. 1, the particular hardware processor used to process offloaded audio data is illustrated as a DSP. It should be appreciated that the inventive arrangements may be implemented using any of a variety of hardware processor types whether a DSP, a Graphics Processing Unit (GPU), a CPU, a System-on-Chip (SoC), a Field Programmable Gate Array, an Application-Specific Integrated Circuit (ASIC), a System-in-Package (SiP), an Intelligence Processing Unit, an Inference Processing Unit, a Neural Processing Unit, or the like. As discussed, in some example implementations, the entirety of system 100 may be implemented as a System-on-Chip or as a SiP. In general, DSP 106 may be implemented as any of a variety of different types of hardware processors. In any case, system 100 is capable of real-time operation. That is, system 100 is capable of receiving audio data, processing the audio data, and outputting the audio data in real-time.

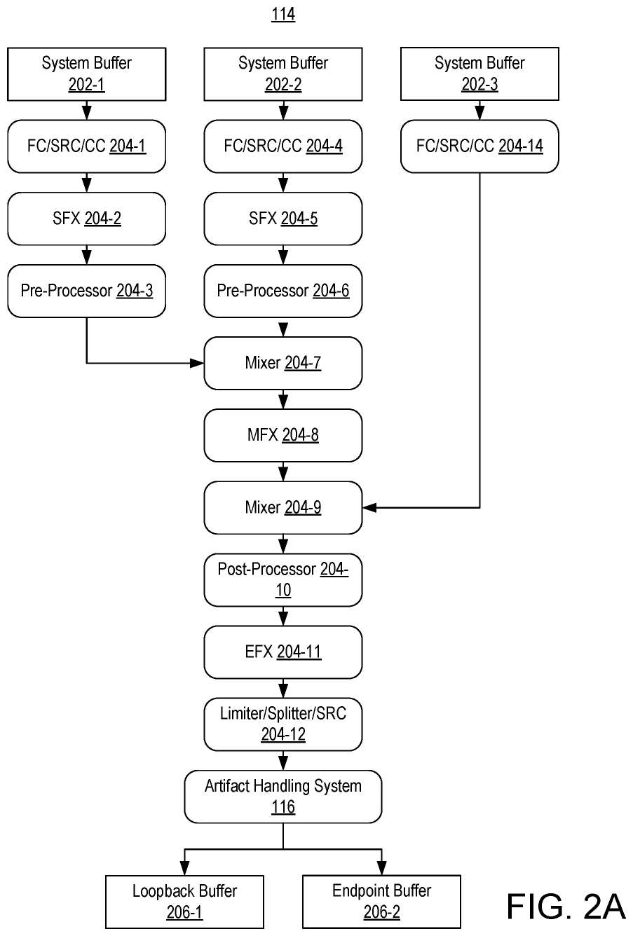

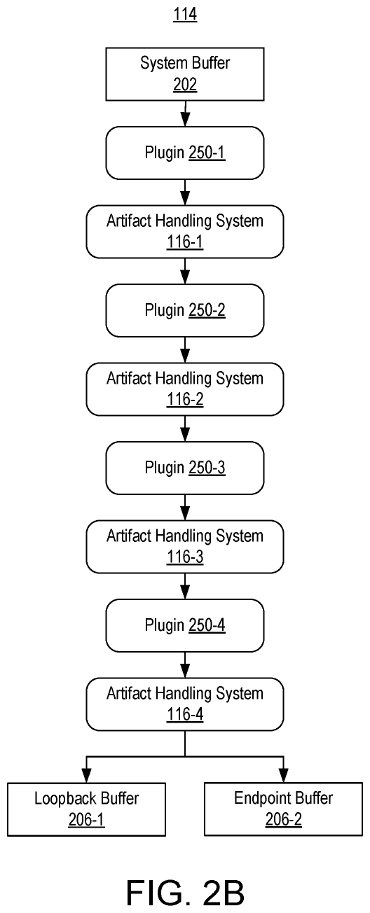

FIG. 2A illustrates an example of audio processing pipeline 114 of FIG. 1. In the example, audio processing pipeline 114 is implemented as a graph including a plurality of different nodes 204. Audio processing pipeline 114 is capable of, and may be dedicated for, processing frames of audio data 112.

In the example, audio processing pipeline 114 includes a plurality of branches each capable of processing frames of audio data 112 obtained from respective system buffers 202 illustrated as system buffers 202-1, 202-2, and 202-3. The first (left) branch of audio processing pipeline 114 obtains frames from system buffer 202-1 and includes nodes 204-1, 204-2, and 204-3. The second (middle) branch includes nodes 204-4, 204-5, 204-6, 204-7, 204-8, 204-9, 204-10, 204-11, and 204-12 followed by artifact handling system 116. The third (right) branch includes node 204-14. As illustrated, the output of node 204-3 flows into node 204-7, which implements a mixer. Similarly, node 204-14 flows into node 204-9, which also implements a mixer.

In the example of FIG. 2A, each node may be implemented as a plugin. Each node 204 is configured to perform one or more audio processing functions. Examples of the audio processing functions that may be performed by nodes 204 may include, but are not limited to, stream effects (SFX), mode effects (MFX), endpoint effects (EFX), format conversion (FC), source rate conversion (SRC), volume control (VC), peak metering (PM), muting, pre-processing (Pre-Processor), post-processing (Post Processor), limiting, signal splitting (not shown), and mixing (mixer) of multiple signals paths or branches.

In the example of FIG. 2A, artifact handling system 116 is located within audio processing pipeline 114. As illustrated, artifact handling system 116 may be located at the end of audio processing pipeline 114, e.g., as the last node that feeds processed audio to a loopback buffer 206-1 and/or an endpoint buffer 206-2. As positioned, artifact handling system 116 is capable of handling any audio artifacts that may have existed in audio data 112 that is fed into audio processing pipeline 114 or that may be introduced into the audio data by operation of one or more nodes 204 of audio processing pipeline 114. Referring to the latter, it may be the case that one or more nodes 204 introduces an audio artifact into a frame of audio data 112 as the frame progresses through audio processing pipeline 114. By locating artifact handling system 116 toward the end of audio processing pipeline 114, artifact handling system 116 is capable of detecting and addressing (e.g., correcting) any such audio artifacts regardless of their origin.

In the example of FIG. 2A, by virtue of the location of artifact handling system 116 within audio processing pipeline 114, artifact handling system 116 may include data stream splitting capabilities to split or duplicate the data stream that is output to loopback buffer 206-1 and/or to an endpoint buffer 206-2. Loopback buffer 206-1 may be used to further process, store, or record processed audio data within system 100. Endpoint buffer 206-2 may be implemented in a memory from which an endpoint (e.g., audio output 108 such as a Universal Serial Bus (USB) circuit or other audio output device) obtains processed audio data to be output or played.

It should be appreciated that the graph implementation of audio processing pipeline 114 illustrated in FIG. 2A is provided for purposes of illustration only. Other implementations of an audio processing pipeline with different plugin(s), plugin organization, and/or hierarchy may be used. In one or more examples, regardless of the particular hierarchy or configuration of audio processing pipeline 114, artifact handling system 116 may be positioned or located at or near the end (e.g., an endpoint) of any such audio processing pipeline. Locating artifact handling system 116 at the end or endpoint of an audio processing pipeline means that artifact handling system 116 is positioned just prior to a buffer such as loopback, buffer 206-1 and/or endpoint buffer 206-2 that is used for rendering, which reduces the impact of the detected audio artifact or eliminates the audio artifact.

In one or more other examples, artifact handling system 116 may be positioned or located elsewhere within an audio processing pipeline. For example, rather than being located at or toward the end, artifact handling system 116 may immediately precede or immediately follow a different node of the audio processing pipeline than illustrated. For example, artifact handling system 116 may be positioned immediately following node 204-3, node 204-7, and/or node 204-9.

In one or more other examples, an audio processing pipeline may include a plurality of different instances of artifact handling system 116 at different locations therein. For example, an artifact handling system 116 implemented as a plugin may be inserted following each node within the audio processing pipeline. In such implementations, in one or more examples, each instance of artifact handling system 116 may be selectively enabled or disabled dynamically, e.g., in real time, and on an individual basis based on conditions detected in system 100 and/or audio processing pipeline 114. While enabled, artifact handling system 116 is operative to detect and address audio artifacts in real time. While disabled, artifact handling system 116 is bypassed such that audio passes through artifact handling system 116 without analysis or modification. In one or more other examples, each instance of artifact handling system 116 may be selectively enabled or disabled on an individual basis based on configuration settings of system 100 and remain in that state until such time that the configuration settings are changed. In this regard, the location, or locations, as the case may be, of artifact handling system 116 (e.g., of the detection of audio artifact(s) and the replacement of frames including any detected audio artifacts) in the audio processing pipeline may be moved during operation of the audio processing pipeline on the digital audio stream.

In one or more examples, artifact handling system 116 or one of a plurality of instances thereof may be located or inserted into the audio processing pipeline following any particular node that is determined to generate audio artifacts with a higher frequency or likelihood than other nodes within the audio processing pipeline. In terms of operation of nodes 204 and the introduction of an audio artifact into audio data by any such node, an audio artifact may be considered a case in which a node of the audio pipeline performs or exhibits erroneous operation. The erroneous operation may lead to a sudden loss of audio data or may introduce unwanted data in addition to and/or in place of the original audio data that may result in an audio artifact that is audible to a user while playing/rendering the digital audio.

FIG. 2B illustrates another example of audio processing pipeline 114 of FIG. 1. In the example, audio processing pipeline 114 has been simplified to better illustrate various operative features of the disclosed technology. It should be appreciated that the example described in connection with FIG. 2B may be implemented with any of a variety of audio processing pipelines having different and/or more complex architectures. Audio processing pipeline 114 is capable of, and may be dedicated for, processing frames of audio data 112. FIG. 2B illustrates an example technique for detecting the particular node responsible for generating audio artifacts, referred to herein as the “source node,” and for selectively enabling different instances of artifact handling system 116 based on the location of the source node within the audio processing pipeline 114. The techniques illustrated and described in connection with FIG. 2B may be performed at runtime and in real time.

In the example, audio processing pipeline 114 includes plugins (e.g., nodes) 250-1, 250-2, 250-3, and 250-4. Plugin 250-1 obtains frames from system buffer 202. In the example, artifact handling system 116 is implemented as a plugin. An instance of artifact handling system 116 (e.g., the plugin implementation thereof) is inserted into audio processing pipeline 114 following each plugin 250.

In one or more examples, by default, only one instance of artifact handling system 116, e.g., artifact handling system 116-4, located at the endpoint, may remain enabled. For example, at least initially, only artifact handling system 116-4 is enabled while each other instance of artifact handling system 116 (e.g., 116-1, 116-2, and 116-3) is bypassed.

In response to detecting an audio artifact by artifact handling system 116-4, a source node detection technique may be implemented. In response to detecting an audio artifact by artifact handling system 116-4, the prior instance of artifact handling system 116 is enabled. For example, in response to detecting an audio artifact by artifact handling system 116-4, artifact handling system 116-3 is enabled. This process may be repeated as further audio artifacts are detected. For example, in response to detecting a further audio artifact by artifact handling system 116-3, artifact handling system 116-2 is enabled and 116-3 is bypassed. In response to detecting yet another audio artifact by artifact handling system 116-2, artifact handling system 116-1 is enabled and artifact handling system 116-2 is bypassed.

In this manner, source node identification may be performed. As noted, the source node is the node, or plugin, that is responsible for creating or introducing the audio artifact into the audio stream. In response to any audio artifact being detected, the prior artifact handling system 116 is enabled while the prior enabled artifact handling system 116 is bypassed. Throughout this process, however, the endpoint artifact handling system 116, i.e., artifact handling system 116-4, remains enabled. This may be repeated until the source node is identified. The source node can be identified by comparing decisions of successive artifact handling system 116 instances. For example, if the technique results in artifact handling system 116-2 detecting and addressing an audio artifact while artifact handling system 116-1 does not, the source node may be identified as plugin 250-2.

Once the process completes and, for purposes of illustration, in response to detecting the source node (e.g., plugin 250-2), artifact handling systems 116-1 and artifact handling system 116-3 may be placed in bypass mode once again. Artifact handling systems 116-2, which is the instance of the artifact handling system either immediately following the source node or the next artifact handling system 116 after the source node, and 116-4 may remain enabled. As noted, in one or more examples, the artifact handling system 116 located at the endpoint node (e.g., artifact handling system 116-4) may remain enabled despite one or more other instances of artifact handling system 116 being enabled to detect and address audio artifacts that may be injected into the audio stream from some other node (e.g., a node outside of the audio processing pipeline 114 or a node not having an artifact handling system 116 immediately following).

In one or more examples, the instance of artifact handling system 116 located at the endpoint may be bypassed in response to enabling another instance of artifact handling system 116 that follows a detected source node.

The process illustrated in FIG. 2B may be performed to detect one or more source nodes in the audio processing pipeline 114 to selectively enable the instance of the artifact handling system 116 following such a node, or following multiple such nodes. As such, during operation, e.g., at runtime, the technique illustrated in FIG. 2B may be performed in response to detection of an audio artifact by artifact handling system 116-4. The technique may be performed periodically or in response to a detected audio artifact. In some examples, once any instance of artifact handling system 116 other than artifact handling system 116-4 that is enabled has not detected an audio artifact for a minimum period of time, that instance of artifact handling system 116 may be bypassed.

In another example, in the case where the source node is plugin 250-2 and artifact handling system 116-4 again detects audio artifacts after a period of not detecting any audio artifacts (e.g., where artifact handling system 116-2 is enabled), the technique illustrated in FIG. 2B may be performed again. The detection of an audio artifact by artifact handling system 116-4 in this case indicates that another node is introducing an audio artifact into the audio stream.

In the example, a sequential enabling of instances of artifact handling system 116 is described where only one additional instance is enabled sequentially up (or down) the pipeline while 116-4 remains enabled. In this example, only two instances of artifact handling system 116 are enabled at any given time to detect the source node thereby conserving power. In other examples, however, where power may not be a concern, more than two instances artifact handling system 116 or all instances of artifact handling system 116 may be enabled to detect the source node (e.g., plugin 250-2) potentially in less time and then leave only instances of artifact handling system 116-4 and 116-2 enabled (e.g., in the case of plugin 250-2 being the source node or other instances as the case may be depending on the particular plugin detected as the source node) while the other instances of artifact handling system 116 are again bypassed.

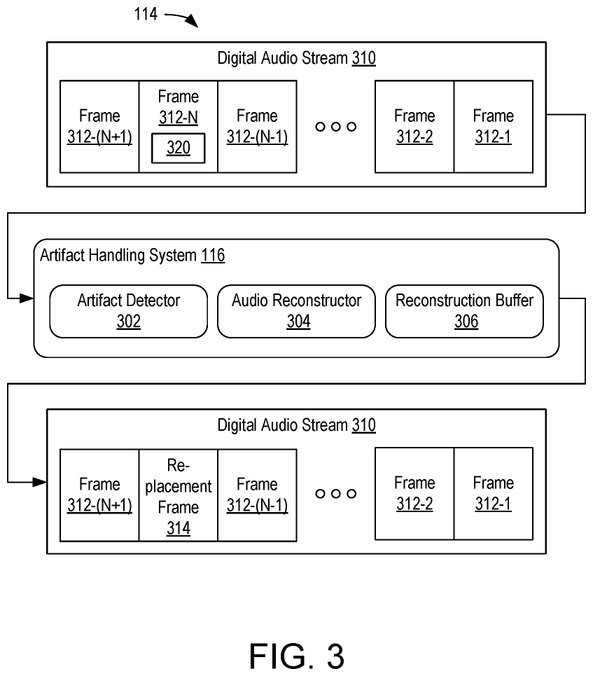

FIG. 3 illustrates an example implementation of artifact handling system 116. In the example of FIG. 3, artifact handling system 116 includes an artifact detector 302 and an audio reconstructor 304. Artifact handling system 116 also includes a reconstruction buffer 306. In some examples, reconstruction buffer 306 may be incorporated within, or as part of, audio reconstructor 304. Artifact detector 302 is capable of detecting audio artifacts in a received digital audio stream. Audio reconstructor 304 is capable of handling any detected audio artifacts within the digital audio stream.

In the example of FIG. 3, audio data 112 is shown that may be processed through audio processing pipeline 114 and through artifact handling system 116. Audio data 112 may be formatted as a digital audio stream 310 including a plurality of frames 312 shown as frames 312-1, 312-2, through 312-(N+1). For purposes of illustration, frame 312-N is an artifact frame that includes an audio artifact 320 therein. Artifact detector 302 is capable of detecting audio artifact 320 within frame 312-N. In response to detection of audio artifact 320, audio reconstructor 304 is capable of generating a replacement frame 314.

In general, audio reconstructor 304 artificially generates replacement frame 314 based on characteristics/features learned from past, e.g., historical, audio data that may be stored reconstruction buffer 306. Past, or prior, audio data stored in reconstruction buffer 306 includes audio samples, e.g., one or more frames 312, preceding the artifact frame 312-N in this example. In general, replacement frame 314 includes artificially generated audio samples that effectively predict what the artifact frame would be without audio artifact 320. Audio reconstructor 304 is capable of replacing frame 312-N within digital audio stream 310 with replacement frame 314.

In one or more examples, artifact detector 302 is implemented as a machine learning model (e.g., a first machine learning model) that has been trained to classify frames of audio as including an artifact or not. An example of a machine learning model used to implement artifact detector 302 is a convolutional neural network (CNN) model. The model may have an architecture that includes multiple stages of convolution layers. The CNN model further may include a dense fully connected layer. An output layer such as a SoftMax layer may be included. The output layer is capable of generating two outputs for a given frame of audio. A first output may specify a probability that a given frame includes an audio artifact (e.g., is an artifact frame). A second output may specify a probability that the given frame does not include an audio artifact (e.g., is a clean frame).

The machine learning model may be trained using training audio data that includes a variety of different types of audio artifacts. The training audio data may be captured in real time in various types of systems with various types of form factors. For purposes of illustration, the real-time audio data (e.g., training digital audio stream) may be specified or denoted as x(n). The particular features used to train artifact detector 302 represent temporal and spatial variations in x(n). These features are also the feature extracted from audio data at runtime, e.g., during inference, to detect audio artifacts. These features, referred to herein as audio artifact features, may include, but are not limited to, Mel-frequency cepstral coefficients (MFCCs), magnitude spectra, phase spectra, and/or short-term and long-term entropies.

Within the discussion below, n represents a number of samples in every kth frame. The kth frame of audio data is represented as x(n). X(N) represents an N points frequency domain representation of the x(n) time domain data. X_{mag}(j) represents magnitude spectra for every kth frame. Xₚₕₛ(j) represents phase spectra for every kth frame

$${ST}_{ENT}^{k} ( n )$$

represents the short-term entropy moving average entropies of the kth frame.

$${LT}_{ENT}^{k} ( n )$$

represents the long-term entropy moving average entropies of the kth frame.

Referring to the artifact detection features, MFCCs are derived from a type of cepstral representation of audio with frequency bands being equally spaced on the Mel scale to mimic the manner in which human beings perceive audio. For purposes of illustration, in general, MFCCs may be derived by segmenting audio into frames, taking a Fast Fourier Transform of each frame, mapping the frequency spectrum obtained by the FFT onto the Mel scale, filtering using Mel-frequency band-specific filters, and calculating the energy across each band. Further processing may be applied to achieve a more compact or compressed representation of the MFCCs.

The magnitude spectrum of X(N) may be calculated as X_{mag}(j)=X(j)*(conjugate of X(j)), where ∀j<N. The phase spectrum of X(N) may be calculated as

$${X}_{phs} ( j ) = \frac{imag ( X ( j ) )}{real ( x ( j ) )} ,$$

where ∀j<N. Regarding short and long-term entropies, the energy of x(n) may be expressed as energy(n)=(ip^{k}(n)*ip^{k}(n)). Short-term entropy may be expressed as

$$S {T}_{ENT}^{k} ( n ) = ∝ ( energy ( n ) ) + ( 1 - {∝}_{st} ) * S {T}_{ENT}^{k} ( n ) ,$$

where {0.8<∝ₛₜ<1; (∀n)}. Long-term entropy may be expressed as

$$L {T}_{ENT}^{k} ( n ) = {∝}_{lt} ( energy ( n ) ) + ( 1 - {∝}_{lt} ) * L {T}_{ENT}^{k} ( n ) ,$$

where {0.01<∝ₗₜ<0.15}; (∀n)}.

As an illustrative and non-limiting example, as audio data is fed to artifact detector 302, artifact detector 302 is capable of extracting or calculating the artifact detection features from the audio data for every (e.g., each) frame. In general, each frame includes approximately 5 milliseconds of audio data. The training process trains artifact detector 302 to recognize audio artifacts in a digital audio stream in real time on a per frame basis based on the artifact detection features extracted from the annotated training audio data. During runtime, e.g., at inference, artifact detector 302 extracts artifact detection features from digital audio stream 310 on a per frame basis and classifies each frame. For example, artifact detector 302 may include a further layer or logic that, based on the two probabilities that are output from artifact detector 302, designates the frame as a clean frame or an artifact frame.

In one or more examples, audio reconstructor 304 is implemented as a machine learning model (e.g., a second machine learning model) that has been trained to generate artificial audio as replacement frame 314. Replacement frame 314 is generated to replicate continuity of the audio data captured in reconstruction buffer 306 within digital audio stream 310. An example of a machine learning model that may be used to implement audio reconstructor 304 is a Long-Short Term Memory (LSTM) model. The LSTM model is a generative model.

Conventional signal processing approaches that rely on statistics rather than machine learning to mitigate the effects of audio artifacts have required a large set of parameters to be computed in real time. Using such a large set of parameters requires large amounts of memory and requires high clock rates. These requirements are often infeasible in systems and/or devices in which audio processing is offloaded from a host processor to another processor such as a DSP. For example, the DSP would require significant memory resources to perform the statistically based processing in real time. In some examples, the implementations described within this disclosure may be used in resource constrained computing devices and/or systems including those that utilize a host processor offloading audio processing to another processor such as a DSP.

In one or more examples, audio reconstructor 304 may be trained with various types of training audio data that covers many, if not most, possible combinations of real time audio data. The training audio data may include sweep signals such as audio signals that contain continuously varying frequency audio data. The training audio data also may include different combinations of sine tones of differing and fixed frequencies. Audio reconstructor 304 is trained to generate replacement frames of audio that match the training audio data given the audio generation features of the training audio data as input.

Audio generation features may include magnitude spectra and phase spectra. That is, audio reconstructor 304 may be trained to generate artificial audio corresponding to ground truth audio based on audio generation features such as magnitude spectra and phase spectra. In one or more other example implementations, audio generation features may include additional features as previously described such as MFCCs and/or entropy.

For purposes of training, audio reconstructor 304 may be trained with segments or blobs of training digital audio of approximately 20 milliseconds in duration/size. In this regard, during inference, audio reconstructor 304 is capable of buffering approximately 20 milliseconds of digital audio stream 310 within reconstruction buffer 306 from which audio generation features may be extracted. In response to detecting that a replacement frame is required, audio reconstructor 304 is capable of generating a replacement frame by processing the features extracted from the buffered portion of the digital audio stream 310. In some cases, the amount of historical data of digital audio stream 310, e.g., the amount of buffered audio data, may be increased beyond 20 milliseconds. For example, in some cases, up to approximately 40 milliseconds of audio data may be stored and used to extract audio generation features for purposes of generating a replacement frame at runtime.

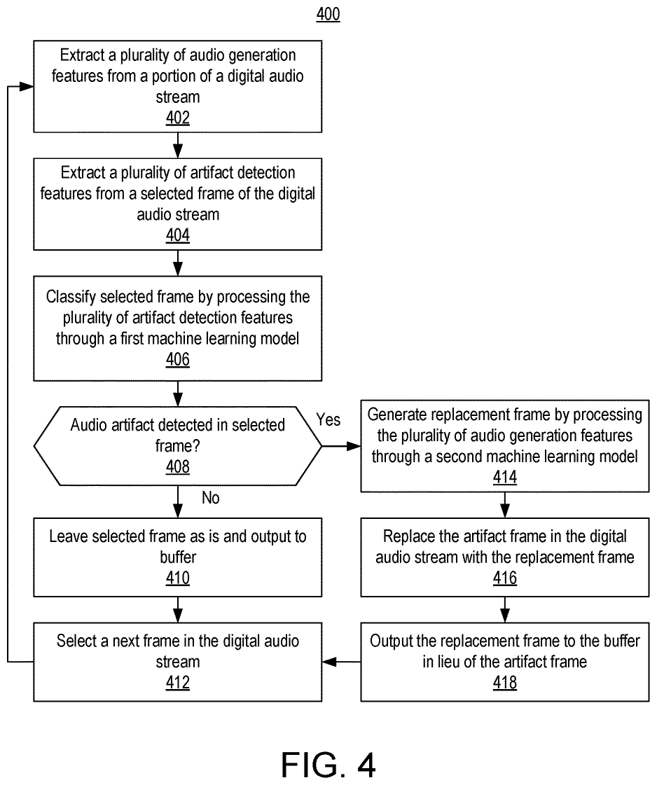

FIG. 4 illustrates an example method 400 of operation for system 100 of FIG. 1. In the example of FIG. 4, method 400 may begin in a state where the host processor 102 is providing audio data 112 to DSP 106 for processing. DSP 106 may execute an audio processing pipeline that includes artifact handling system 116.

In block 402, audio reconstructor 304 is capable of extracting a plurality of audio generation features from a portion of digital audio stream 310 preceding a selected frame of the digital audio stream. For purposes of discussion, consider an example where the selected frame, e.g., the current frame that is being processed for audio artifact detection, is frame 312-N. In the example, audio reconstructor 304 is capable of operating on a plurality of preceding audio samples such as frames 312-1, 312-2, through 312-(N−1). The portion of digital audio stream 310 from which the audio generation features are extracted may be one or more frames 312 that immediately precede the selected frame 312. As discussed, the quantity or amount of the portion of digital audio stream 310 from which the audio generation features are extracted may be approximately 20 milliseconds in duration (e.g., approximately 4 frames). In other examples, the duration of buffered audio data from which the audio generation features are extracted may be longer.

As discussed, examples of the audio generation features that may be extracted by audio reconstructor 304 and subsequently used to generate replacement frames may include, but are not limited to, magnitude spectra and/or phase spectra. In one or more other examples, additional features such as MFCCs and/or short-term and long-term entropies also may be used as audio generation features.

In block 404, artifact detector 302 is capable of extracting a plurality of artifact detection features from the selected frame 312-N. As discussed, examples of artifact detection features include, but are not limited to, MFCCs, magnitude spectra, phase spectra, and/or short-term and long-term entropies from selected frame 312-N.

In block 406, artifact detector 302 is capable of detecting whether an audio artifact exists within the selected frame 312-N. For example, artifact detector 302 is capable of processing the plurality of artifact detection features of the selected frame 312-N to classify 312-N as a clean frame or an artifact frame. As noted, artifact detector 302 may be implemented as a machine learning model trained to detect audio artifacts. The machine learning model may be a CNN.

In block 408, in response to detecting that selected frame 312-N includes no audio artifact therein (e.g., detecting that selected frame 312-N is a clean frame), method 400 continues to block 410. In response to detecting that selected frame 312-N includes an audio artifact therein (e.g., detecting that selected frame 312-N is an artifact frame), method 400 continues to block 414.

In block 410, artifact handling system 116 is capable of leaving selected frame 312-N as is (e.g., unchanged). As such, the selected frame 312-N, as part of digital audio stream 310, may be output or stored in a buffer such as loopback buffer 206-1 or endpoint buffer 206-2.

After block 410, method 400 may continue to block 412 where a next frame in digital audio stream 310 is selected for processing. For example, the next frame may be the frame immediately following frame 312-N (e.g., 312-(N+1).

Continuing with block 414, in response to detecting an audio artifact within frame 312-N, audio reconstructor 304 is capable of generating a replacement frame by processing the audio generation features through a second machine learning model trained to generate replacement frames. As noted, the second machine learning model may be implemented as an LSTM model. Further, as noted, the audio generation features include those already mentioned as extracted from a portion of the digital audio stream preceding the selected frame 312-N. In block 416, audio reconstructor 304 is capable of replacing the selected frame 312-N of digital audio stream 310 that includes the audio artifact (e.g., audio artifact 320) with the replacement frame (e.g., replacement frame 314).

After block 416, method 400 may continue to block 418. In block 418, artifact handling system 116 is capable of outputting the replacement frame, in lieu of the selected frame 312-N. That is, artifact handling system 116 is capable of storing the replacement frame instead of the selected frame 312-N in a buffer such as loopback buffer 206-1 or endpoint buffer 206-2. After block 418, method 400 may continue to block 412 where a next frame in digital audio stream 310 is selected for processing.

As method 400 continues to iterate, it should be appreciated that the portion of the digital audio stream from which audio generation features are extracted may be updated. For example, the audio data stored in reconstruction buffer 306 for each iteration of method 400 may be updated. As an example, in the case where reconstruction buffer 306 stores frames 312-1 through 312-(N−1), frame 312-1 may be ejected (e.g., deleted, purged, or overwritten) as the oldest frame in a next iteration of method 400. Another frame may be added to reconstruction buffer 306 to take the place of frame 312-1.

The frame that is added may be the frame that was ultimately output or stored in the buffer (e.g., endpoint buffer 206-2). For example, in the case where selected frame 312-N was a clean frame, then the selected frame 312-N is added to reconstruction buffer 306 to replace frame 312-1. Thus, frame 312-N is included in the portion of audio from which the audio generation features are extracted for the next iteration of method 400 in which frame 312-(N+1) is the selected frame upon which audio artifact detection is performed. In the case where selected frame 312-N is an artifact frame, replacement frame 314 is added to reconstruction buffer 306 in place of frame 312-1. In that case, replacement frame 314 is included in the portion of audio from which the audio generation features are extracted for the next iteration of method 400 where frame 312-(N+1) is the selected frame upon which audio artifact detection is performed.

The terminology used herein is for the purpose of describing particular examples only and is not intended to be limiting. Notwithstanding, several definitions that apply throughout this document are expressly defined as follows.

As defined herein, the singular forms “a,” “an,” and “the” are intended to include the plural forms as well, unless the context clearly indicates otherwise.

As defined herein, the term “approximately” means nearly correct or exact, close in value or amount but not precise. For example, the term “approximately” may mean that the recited characteristic, parameter, or value is within a predetermined amount of the exact characteristic, parameter, or value.

As defined herein, the terms “at least one,” “one or more,” and “and/or,” are open-ended expressions that are both conjunctive and disjunctive in operation unless explicitly stated otherwise.

As defined herein, the term “automatically” means without human intervention.

As defined herein, the term “computer-readable storage medium” means a storage medium that contains or stores program instructions for use by or in connection with an instruction execution system, apparatus, or device. As defined herein, a “computer-readable storage medium” is not a transitory, propagating signal per se. The various forms of memory, as described herein, are examples of a computer-readable storage medium or two or more computer-readable storage mediums. A non-exhaustive list of examples of a computer-readable storage medium include an electronic storage device, a magnetic storage device, an optical storage device, an electromagnetic storage device, a semiconductor storage device, or any suitable combination of the foregoing. A non-exhaustive list of more specific examples of a computer-readable storage medium may include: a portable computer diskette, a hard disk, a RAM, a read-only memory (ROM), an erasable programmable read-only memory (EPROM or Flash memory), an electronically erasable programmable read-only memory (EEPROM), a static random-access memory (SRAM), a double-data rate synchronous dynamic RAM memory (DDR SDRAM or “DDR”), a portable compact disc read-only memory (CD-ROM), a digital versatile disk (DVD), a memory stick, a floppy disk, or the like.

As defined herein, “data processing system” means one or more hardware systems configured to process data, each hardware system including at least one hardware processor programmed to initiate operations and memory.

As defined herein, the terms “in response to” and “responsive to” mean responding or reacting readily to an action or event. Thus, if a second action is performed “in response to” or “responsive to” a first action, there is a causal relationship between an occurrence of the first action and an occurrence of the second action. The term “responsive to” indicates the causal relationship. In some cases, other terms such as “if,” “when,” or “upon” are used and also convey a causal relationship.

As defined herein, the term “user” refers to a human being.

As defined herein, the term “hardware processor” means at least one hardware circuit. The hardware circuit may be configured to carry out instructions contained in program code. The hardware circuit may be an integrated circuit. Examples of a hardware processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, a controller, and a Graphics Processing Unit (GPU).

As defined herein, the term “real time” means a level of processing responsiveness that a user or system senses as sufficiently immediate for a particular process or determination to be made, or that enables the processor to keep up with some external process.

As defined herein, the term “substantially” means that the recited characteristic, parameter, or value need not be achieved exactly, but that deviations or variations, including for example, tolerances, measurement error, measurement accuracy limitations, and other factors known to those of skill in the art, may occur in amounts that do not preclude the effect the characteristic was intended to provide.

The terms first, second, etc., may be used herein to describe various elements. These elements should not be limited by these terms, as these terms are only used to distinguish one element from another unless stated otherwise or the context clearly indicates otherwise.

A computer program product may include a computer-readable storage medium (or mediums) having computer-readable program instructions thereon for causing a processor to carry out aspects of the implementations described herein. Within this disclosure, the terms “program code,” “program instructions,” and “computer-readable program instructions” are used interchangeably. Computer-readable program instructions described herein may be downloaded to respective computing/processing devices from a computer-readable storage medium or to an external computer or external storage device via a network, for example, the Internet, a LAN, a WAN and/or a wireless network. The network may include copper transmission cables, optical transmission fibers, wireless transmission, routers, firewalls, switches, gateway computers and/or edge devices including edge servers. A network adapter card or network interface in each computing/processing device receives program instructions from the network and forwards the computer-readable program instructions for storage in a computer-readable storage medium within the respective computing/processing device.

Program instructions for carrying out operations for the implementations described herein may be assembler instructions, instruction-set-architecture (ISA) instructions, machine instructions, machine dependent instructions, microcode, firmware instructions, or either source code or object code written in any combination of one or more programming languages, including an object-oriented programming language and/or procedural programming languages. Program instructions may include state-setting data. The program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or a WAN, or the connection may be made to an external computer (for example, through the Internet using an Internet Service Provider). In some cases, electronic circuitry including, for example, programmable logic circuitry, an FPGA, or a PLA may execute the program instructions by utilizing state information of the program instructions to personalize the electronic circuitry, in order to perform aspects of the implementations described herein.

Certain aspects of the implementations are described herein with reference to flowchart illustrations and/or block diagrams of methods, apparatus (systems), and computer program products. It will be understood that each block of the flowchart illustrations and/or block diagrams, and combinations of blocks in the flowchart illustrations and/or block diagrams, may be implemented by program instructions, e.g., program code.

These program instructions may be provided to a processor of a computer, special-purpose computer, or other programmable data processing apparatus to produce a machine, such that the program instructions, which execute via the processor of the computer or other programmable data processing apparatus, create means for implementing the functions/acts specified in the flowchart and/or block diagram block or blocks. These program instructions may also be stored in a computer-readable storage medium that can direct a computer, a programmable data processing apparatus, and/or other devices to function in a particular manner, such that the computer-readable storage medium having program instructions stored therein comprises an article of manufacture including program instructions which implement aspects of the operations specified in the flowchart and/or block diagram block or blocks.

The program instructions may also be loaded onto a computer, other programmable data processing apparatus, or other device to cause a series of operations to be performed on the computer, other programmable apparatus or other device to produce a computer implemented process, such that the program instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various aspects of the implementations. In this regard, each block in the flowchart or block diagrams may represent a module, segment, or portion of instructions, which comprises one or more program instructions for implementing the specified operations.

In some alternative implementations, the operations noted in the blocks may occur out of the order noted in the figures. For example, two blocks shown in succession may be executed substantially concurrently, or the blocks may sometimes be executed in the reverse order, depending upon the functionality involved. In other examples, blocks may be performed generally in increasing numeric order while in still other examples, one or more blocks may be performed in varying order with the results being stored and utilized in subsequent or other blocks that do not immediately follow. It will also be noted that each block of the block diagrams and/or flowchart illustration, and combinations of blocks in the block diagrams and/or flowchart illustration, may be implemented by special purpose hardware-based systems that perform the specified functions or acts or carry out combinations of special purpose hardware and program instructions.

The descriptions of the various implementations of the disclosed technology have been presented for purposes of illustration, but are not intended to be exhaustive or limited to the examples disclosed. Many modifications and variations will be apparent to those of ordinary skill in the art without departing from the scope and spirit of the described examples. The terminology used herein was chosen to best explain the principles of the examples, the practical application or technical improvement over technologies found in the marketplace, or to enable others of ordinary skill in the art to understand the examples disclosed herein.

What is claimed is:

1. A method, comprising:
extracting a plurality of audio generation features from a portion of a digital audio stream preceding a selected frame of the digital audio stream;
extracting a plurality of artifact detection features from the selected frame;
detecting an audio artifact within the selected frame by processing the plurality of artifact detection features through a first machine learning model trained to detect audio artifacts;
in response to detecting the audio artifact, generating a replacement frame by processing the audio generation features through a second machine learning model trained to generate replacement frames; and
replacing, within the digital audio stream, the selected frame including the audio artifact with the replacement frame.

2. The method of claim 1, wherein the plurality of audio generation features include magnitude spectra of the portion of the digital audio stream preceding the selected frame and the plurality of artifact detection features include magnitude spectra of the selected frame.

3. The method of claim 1, wherein the plurality of audio generation features include phase spectra of the portion of the digital audio stream preceding the selected frame and the plurality of artifact detection features include phase spectra of the selected frame.

4. The method of claim 1, wherein the plurality of artifact detection features further include one or more of Mel-frequency cepstral coefficients (MFCCs), magnitude spectra, phase spectra, or short-term and long-term entropies.

5. The method of claim 1, wherein the first machine learning model is a convolutional neural network.

6. The method of claim 1, wherein the second machine learning model is a generative Long-Short Term Memory (LSTM) model.

7. The method of claim 1, wherein the detecting of the audio artifact and the replacing of the selected frame occurs at one or more locations including an endpoint within an audio processing pipeline operating on the digital audio stream.

8. The method of claim 1, further comprising:
moving a location of the detecting of the audio artifact and the replacing of the selected frame within an audio processing pipeline during operation of the audio processing pipeline on the digital audio stream.

9. A system, comprising:
a hardware processor; and
one or more computer-readable storage mediums having program instructions stored thereon to cause the hardware processor to perform operations comprising:
extracting a plurality of audio generation features from a portion of a digital audio stream preceding a selected frame of the digital audio stream;
extracting a plurality of artifact detection features from the selected frame;
detecting an audio artifact within the selected frame by processing the plurality of artifact detection features through a first machine learning model trained to detect audio artifacts;
in response to detecting the audio artifact, generating a replacement frame by processing the audio generation features through a second machine learning model trained to generate replacement frames; and
replacing, within the digital audio stream, the selected frame including the audio artifact with the replacement frame.

10. The system of claim 9, wherein the plurality of audio generation features include magnitude spectra of the portion of the digital audio stream preceding the selected frame and the plurality of artifact detection features include magnitude spectra of the selected frame.

11. The system of claim 9, wherein the plurality of audio generation features include phase spectra of the portion of the digital audio stream preceding the selected frame and the plurality of artifact detection features include phase spectra of the selected frame.

12. The system of claim 9, wherein the plurality of artifact detection features further include one or more of Mel-frequency cepstral coefficients (MFCCs), magnitude spectra, phase spectra, or short-term and long-term entropies.

13. The system of claim 9, wherein the first machine learning model is a convolutional neural network.

14. The system of claim 9, wherein the second machine learning model is a generative Long-Short Term Memory (LSTM) model.

15. The system of claim 9, wherein the detecting of the audio artifact and the replacing of the selected frame occurs at one or more locations including an endpoint within an audio processing pipeline operating on the digital audio stream.

16. The system of claim 9, wherein the operations further comprise:
moving a location of the detecting of the audio artifact and the replacing of the selected frame within an audio processing pipeline during operation of the audio processing pipeline on the digital audio stream.

17. A computer program product, comprising:
one or more computer-readable storage mediums having program instructions stored thereon, wherein the program instructions are executable by computer hardware to cause the computer hardware to initiate operations comprising:
extracting a plurality of audio generation features from a portion of a digital audio stream preceding a selected frame of the digital audio stream;
extracting a plurality of artifact detection features from the selected frame;
detecting an audio artifact within the selected frame by processing the plurality of artifact detection features through a first machine learning model trained to detect audio artifacts;
in response to detecting the audio artifact, generating a replacement frame by processing the audio generation features through a second machine learning model trained to generate replacement frames; and
replacing, within the digital audio stream, the selected frame including the audio artifact with the replacement frame.

18. The computer program product of claim 17, wherein the plurality of audio generation features include magnitude spectra of the portion of the digital audio stream preceding the selected frame and the plurality of artifact detection features include magnitude spectra of the selected frame.

19. The computer program product of claim 17, wherein the plurality of audio generation features include phase spectra of the portion of the digital audio stream preceding the selected frame and the plurality of artifact detection features include phase spectra of the selected frame.

20. The computer program product of claim 17, wherein:
the first machine learning model is a convolutional neural network; and
the second machine learning model is a generative Long-Short Term Memory (LSTM) model.
